(19) United States
(12) Patent Application Publication
(10) Pub. No.: US 2013/0128495 A1
(43) Pub. Date: May 23, 2013

(54) METHOD AND SYSTEM FOR MANAGING APPLIANCE EQUIPMETS

(71) Applicant: Mathieu AUDET, Montreal (CA)

(72) Inventor: Mathieu AUDET, Montreal (CA)

(21) Appl. No.: 13/746,168

(22) Filed: Jan. 21, 2013

Related U.S. Application Data
(63) Continuation of application No. 12/833,930, filed on Jul. 9, 2010.
(60) Provisional application No. 61/224,169, filed on Jul. 9, 2009.
(60) Provisional application No. 61/234,493, filed on Aug. 17, 2009.
(60) Provisional application No. 61/234,500, filed on Aug. 17, 2009.

(51) Int. Cl. F25D 27/00

(52) U.S. Cl. CPC F25D 27/005; H04L 65/403
USPC 362/92; 709/204

(57) ABSTRACT

A method and apparatus adapted to sense improper functioning of an appliance. If the appliance does not function properly, a signal is sent to warn of the improper functioning appliance.

### CROSS-REFERENCES

The present United States patent application relates to, claims priority from and is a continuing application of U.S. patent application Ser. No. 12/833,930, filed Jul. 9, 2010, entitled METHOD AND SYSTEM FOR MANAGING APPLIANCE EQUIPMENTS, which relates to and claims priority from United States patent application relates to and claims priority from U.S. provisional patent application No. 61/224,169, filed on Jul. 9, 2009, entitled REFRIGERATOR BIXI GPS SUPPORT, from U.S. provisional patent application No. 61/234,493, filed on Jul. 17, 2009, entitled REFRIGERATOR BIXI GPS SUPPORT 2, and from U.S. provisional patent application No. 61/234,500, filed on Jul. 17, 2009, entitled REFRIGERATOR BIXI GPS SUPPORT 3. All the above patent applications are incorporated herein by reference in their entirety.

### BACKGROUND OF THE INVENTION

1. Field of the Invention

The present invention generally relates to a method and a device for determining the conditions of use of a refrigerator, interpreting the working conditions and providing actions in accordance with predetermined settings. More precisely, the present invention relates to a method and a device for communicating temperature signal through a network and managing the light inside the refrigerator.

2. Description of the Related Art

Refrigerators and freezers, generally, are provided with an internal light to allow a user to better see their content. The internal white light has a single lighting strength that comes off at the opening of the door. Strong light inside the refrigerator is desirable when the ambient light is strong, like under daylight, but is too strong for low light conditions, at night for instance. When a user wakes up at night and opens the refrigerator s/he is blasted with a strong light that prevents the user to properly appreciate the content of the refrigerator. Instead, the strong light interferes with the “night vision” of the user, which might even be painful.

Refrigerators and freezers have to remain within a specific temperature zone to properly keep and preserve food stored therein. Preservation of the food is not possible when the internal temperature of the refrigerator or the freezer is too high. Conversely, the content of the refrigerator freezes when the internal temperature is too low thus damaging the food contained therein. The temperature is normally maintained within a desirable level but it could get outside its normal range if, for instance, the door remains open for a long period of time or if a mechanical malfunction of the appliance occurs. If the user of the refrigerator or the freezer is warned that there is a problem with the device it could be possible to correct the situation or save the food stored in the device.

In light of these reasons, there is a need for an improved method and device that provides a better light management and warn a user when the temperature reaches out a predetermined operating range.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Is provided hereby a method to manage the interior light intensity of a refrigerator/freezer in consideration of the ambient light intensity to prevent blinding the user of the device under low ambient light condition in accordance with an embodiment of the invention.

Is provided hereby an external light sensor on a refrigerator/freezer that is adapted to influence the internal light intensity of the refrigerator/freezer in accordance with an embodiment of the invention.

Is provided hereby a refrigerator/freezer adapted to modulate the light therein in function of the external ambient light to prevent blinding a user who opens the door of the refrigerator/freezer at night in accordance with an embodiment of the invention.

Is provided hereby a refrigerator/freezer that uses an external light sensor or a geographical localization, date and time information and weather conditions to determine the optimal ambient light condition at a precise moment and adjust the internal light intensity accordingly in accordance with an embodiment of the invention.

Is provided hereby a method to modulate the internal light of a refrigerator/freezer (with color, intensity or alternation) to inform a user of the refrigerator/freezer that the internal temperature is outside a predetermined threshold in accordance with an embodiment of the invention.

Is provided hereby a refrigerator/freezer that modulate its internal light to warn a user of a refrigerator/freezer that the refrigerator/freezer has an issue that needs to be taken care of in accordance with an embodiment of the invention.

Is provided hereby a refrigerator/freezer that sends a signal to inform a user of a refrigerator/freezer that the internal temperature of the refrigerator/freezer is outside a predetermined threshold; the refrigerator/freezer being connected to a network and adapted to send a signal as one of an SMS, MMS, email or voice communication to a computer, a mobile device and a mobile phone in accordance with an embodiment of the invention.

Is provided hereby a method for estimating the evolution of the internal temperature of a refrigerator/freezer based on past usage data when the refrigerator/freezer reaches outside a predetermined temperature range to provide an estimation of how much time remains to save the goods stored therein in accordance with an embodiment of the invention.

It is hereby provided a door position sensor and/or an accelerometer disposed in the door or a refrigerator/freezer to identify the position of the door and movements of the door provided by a user to anticipate and adapt the light strength in the refrigerator/freezer in accordance with an embodiment of the invention.

At least one aspect of the present invention provides a non-transitory computer-readable medium adapted to store thereon computer-readable instructions that, when executed with a computer, provide a method of informing of an appliance malfunction, the method comprising detecting a door of an appliance is open; and transmitting a message through a network when a predetermined threshold is exceeded to warn the door of the appliance is open, in accordance with at least one embodiment of the invention.

Other objects, advantages and features will become readily apparent to the people skilled in the art upon reading the following descriptions that makes reference to the accompanying drawings.

### BRIEF DESCRIPTION OF THE DRAWINGS

In the appended drawing,

FIG. 1 is an exemplary schematic illustration of a cooling device network;

FIG. 2 is an exemplary schematic illustration of a cooling device and computer devices network;

FIG. 3 is an exemplary schematic illustration of a typical computer system;

FIG. 4 is an exemplary schematic illustration of a computer system of an exemplary cooling device;

FIG. 5 is an exemplary schematic block diagram of a typical cooling device and other networked devices;

FIG. 6 is a schematic block diagram of an exemplary method for modulating the internal light intensity of a cooling device in function of the ambient light intensity;

FIG. 7 is an exemplary diagram of the evolution of the strength of the internal light of a cooling device in function of time;

FIG. 8 is an exemplary diagram of the evolution of the strength of the internal light of a cooling device in function of time;

FIG. 9 is an exemplary schematic block diagram of an exemplary method for sending a message to another device when the internal temperature of a cooling device is outside its normal operating range with statistical information leading to an evaluation of the internal temperature evolution;

FIG. 10 is a block diagram illustrating exemplary steps to associate a condition to a corresponding light effect in the cooling device; and

FIG. 11 is a block diagram illustrating exemplary steps to associate a condition to a corresponding message originating from a cooling device.

### DESCRIPTION OF EMBODIMENT(S) OF THE INVENTION

The present invention is now described with reference to the figures. In the following description, for purposes of explanation, numerous specific details are set forth in order to provide a thorough understanding of the present invention. It may be evident, however, that the present invention may be practiced without these specific details. In other instances, well-known structures and devices are shown in block diagram or flow chart form in order to facilitate describing the present invention.

Exemplary Network

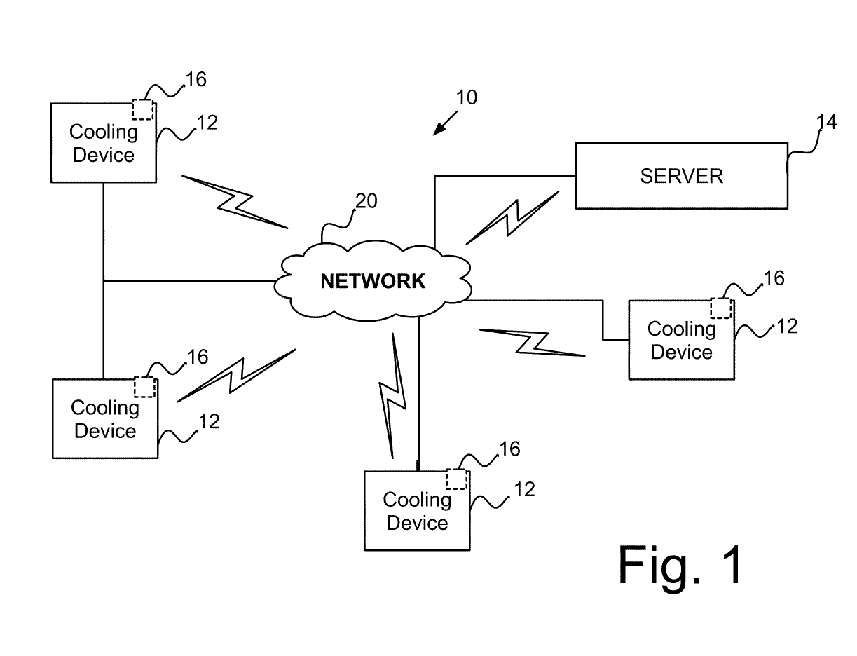

FIG. 1 illustrates an exemplary network 10 in which a system and method, consistent with the present invention, may be implemented. The network 10 may include multiple cooling devices 12, in the present situation a refrigerator or a freezer, provided with embedded electronics capable of sensing physical phenomenon associated with the cooling device 12 and capable of connecting to a server 14 with a management system 16 through a network 20. The embedded electronics will be referred to as a general purposed computer system to define its components and properties that are analogous to a computer system and be referred to as a management system 16 thereafter once embedded in the cooling device. The network 20 may include a local area network (LAN), a wide area network (WAN), a phone network, such as the Public Switched Phone Network (PSTN), an intranet, the Internet, Wi-Fi, WiMAX or a combination of networks. Four cooling devices 12 and one server 14 has been illustrated connected to network 20 for simplicity. In practice, there may be more or less cooling devices 12 and servers 14. Also, in some instances, a cooling device 12 may perform the functions of a server 14. Alternatively, each cooling device 12 can connect to the network 20 alone with embedded communication equipment (not illustrated) that could illustratively be adapted to communicate with the network 14, with Internet protocol (IP).

The cooling devices 12 may include devices, such as, as mentioned above but not limited thereto, refrigerators or freezers, capable of connecting to the network 20. The cooling devices 12 may transmit data over the network 20 or receive data from the network 20 via a wired, wireless, or optical connection.

The server 14 may include one or more types of computer systems, such as a mainframe, minicomputer, or personal computer, capable of connecting to the network 20 to enable the server 14 to communicate with cooling devices 12. In alternative implementations, the server 14 may include mechanisms for directly connecting to one or more cooling devices 12. The server 14 may transmit data over the network 20 or receive data from the network 20 via a wired, wireless, or optical connection.

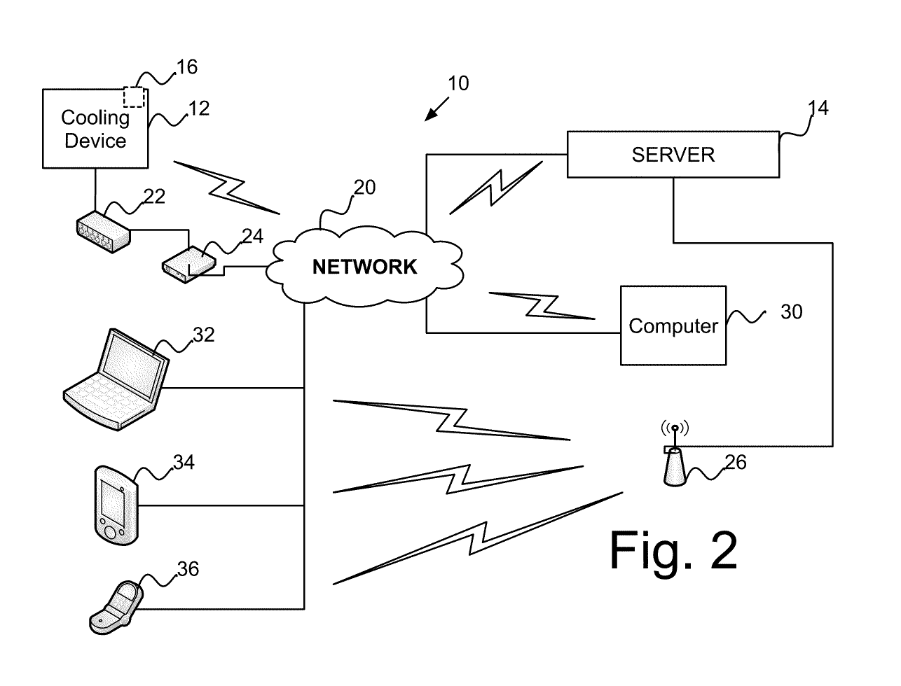

In an implementation consistent with the present invention, the server 14 may be used to communicate with other cooling devices 12 and other machines capable of communicating with the network 20 via a wired (represented with solid lines in the Figures) or a wireless connection (represented with lightening in the Figures) using a wireless transmitter 26. With reference to FIG. 2, the network 20 includes the server 14 that is adapted to communicate with the cooling device 12 optionally using an embedded or exterior hub 22 and modem 24. The server 14 and the cooling device 12 can communicate with other computers 30, portable computers 32, personal digital assistants 34 or mobile phones 36. Communications can be provided upstream or downstream for all connected devices.

Exemplary Client Architecture

The following discussion provides a brief, general description of an exemplary apparatus in which at least some aspects of the present invention may be implemented. The present invention will be described in the general context of computer-executable instructions, such as program modules, being executed by a computerized device having modules therein. However, methods of the present invention may be affected by other apparatus. Program modules may include routines, programs, objects, components, data structures, applets, WEB 2.0 type of evolved networked centered applications, etc. that perform a task(s) or implement particular abstract data types. Moreover, these skilled in the art will appreciate that at least some aspects of the present invention may be practiced with other configurations, including hand-held devices, multiprocessor system, microprocessor-based or programmable consumer electronics, network computers, minicomputers, set top boxes, mainframe computers, gaming console and the like. At least some aspects of the present invention may also be practiced in distributed computing environments where tasks are performed by remote processing devices linked through a communications network. In a distributed computing environment, program modules may be located in local and/or remote memory storage devices.

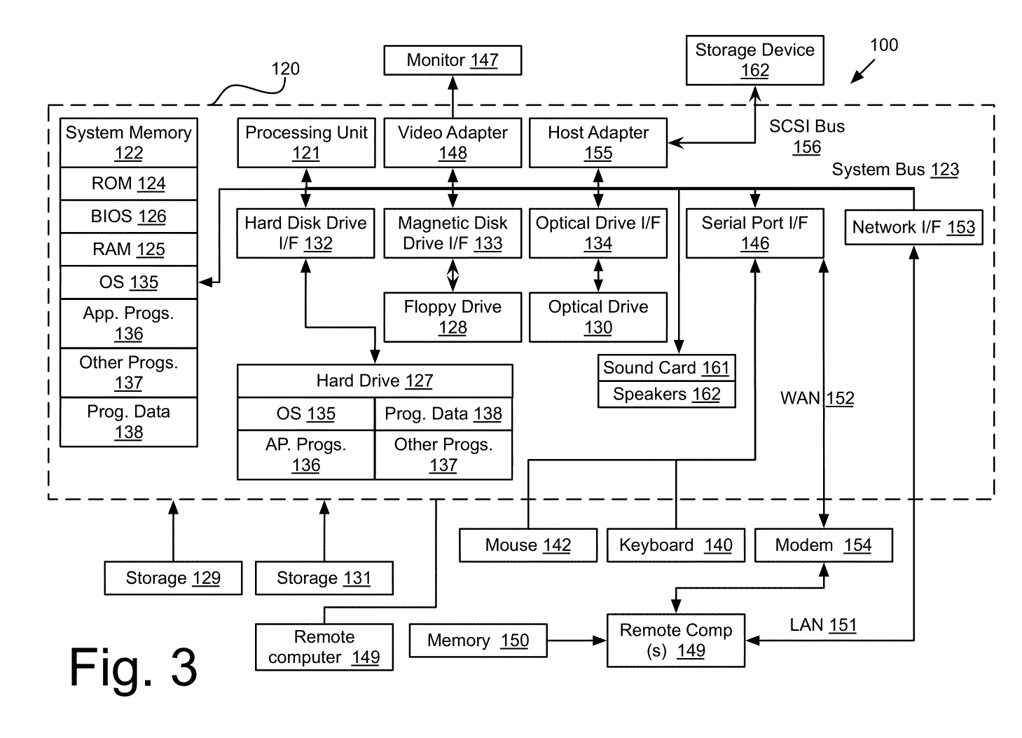

With reference to FIG. 3, an exemplary apparatus 100 for implementing at least some aspects of the present invention includes a general purpose computing device in the form of a computerized machine 120 or in the form of a computerized portable apparatus. The computerized machine 120 generally includes a processing unit 121, a system memory 122, and a system bus 123 that couples various system components, including the system memory 122, to the processing unit 121. The system bus 123 may be any of several types of bus structures including a memory bus or memory controller, a peripheral bus, and a local bus using any of a variety of bus architectures. The system memory may include read only memory (ROM) 124 and/or random access memory (RAM) 125. A basic input/output system 126 (BIOS), containing basic routines that help to transfer data between elements within the computerized machine 120, such as during start-up, may be stored in ROM 124. The computerized machine 120 may also include a hard disk drive 127 for reading from and writing to a hard disk, (not shown), a magnetic disk drive 128 for reading from or writing to a (e.g., removable) magnetic disk 129, and an optical disk drive 130 for reading from or writing to a removable (magneto) optical disk 131 such as a compact disk or other (magneto) optical media. The hard disk drive 127, magnetic disk drive 128, and (magneto) optical disk drive 130 may be coupled with the system bus 123 by a hard disk drive interface 132, a magnetic disk drive interface 133, and a (magneto) optical drive interface 134, respectively. The drives and their associated storage media provide nonvolatile (or persistent) storage of machine-readable instructions, data structures, program modules and other data for the computerized machine 120. Although the exemplary environment described herein employs a hard disk, a removable magnetic disk 129 and a removable optical disk 131, these skilled in the art will appreciate that other types of storage media, such as magnetic cassettes, flash memory cards, digital video disks, Bernoulli cartridges, random access memories (RAMs), read only memories (ROM), and the like, may be used instead of, or in addition to, the storage devices introduced above.

A number of program modules may be stored on the hard disk 127, magnetic disk 129, (magneto) optical disk 131, ROM 124 or RAM 125, such as an operating system 135 (for example, Windows® NT™ 4.0, sold by Microsoft® Corporation of Redmond, Wash. Or an alternate proprietary operating system adapted to provide only the functions required by the present cooling devices 12), one or more application programs 136, other program modules 137 (such as “Alice”, which is a research system developed by the User Interface Group at Carnegie Mellon University available at www.Alice.org, OpenGL from Silicon Graphics Inc. of Mountain View Calif., or Direct 3D from Microsoft Corp. of Bellevue Wash.), and/or program data 138 for example.

A user may enter commands and data into the computerized machine 120 through input devices, such as a keyboard 140, a camera 141 and pointing device 142 for example. Other input devices (not shown) such as a microphone, joystick, game pad, satellite dish, scanner, a touch sensitive screen, accelerometers adapted to sense movements of the user or movements of a device, or the like may also be included. These and other input devices are often connected to the processing unit 121 through a serial port interface 146 coupled to the system bus. However, input devices may be connected by other interfaces, such as a parallel port, a game port, blue tooth connection or a universal serial bus (USB). For example, since the bandwidth of the camera 141 may be too great for the serial port, the video camera 141 may be coupled with the system bus 123 via a video capture card (not shown). The video monitor 147 or other type of display device may also be connected to the system bus 123 via an interface, such as a video adapter 148 for example. The video adapter 148 may include a graphics accelerator. One or more speaker 162 may be connected to the system bus 123 via a sound card 161 (e.g., a wave table synthesizer such as product number AWE64 Gold Card from Creative® Labs of Milpitas, Calif.). In addition to the monitor 147 and speaker(s) 162, the computerized machine 120 may include other peripheral output devices (not shown), such as a printer for example. As an alternative or an addition to the video monitor 147, a stereo video output device, such as a head mounted display or LCD shutter glasses for example, could be used.

The computerized machine 120 may operate in a networked environment, which defines logical connections to one or more remote computers, such as a remote computer 149. The remote computer 149 may be another personal computer, a server, a router, a network PC, a peer device or other common network node, and may include many or all of the elements described above relative to the computerized machine 120, although only a memory storage device 150 has been illustrated in FIG. 3. The logical connections depicted in FIG. 2 include a local area network (LAN) 151 and a wide area network (WAN) 152, an intranet and the Internet.

When used in a LAN, the computerized machine 120 may be connected to the LAN 151 through a network interface adapter (or “NIC”) 153. When used in a WAN, such as the Internet, the computerized machine 120 may include a modem 154 or other means for establishing communications over the wide area network 152 (e.g. Wi-Fi, WinMax). The modem 154, which may be internal or external, may be connected to the system bus 123 via the serial port interface 146. In a networked environment, at least some of the program modules depicted relative to the computerized machine 120 may be stored in the remote memory storage device. The network connections shown are exemplary and other means of establishing a communications link between the computers may be used.

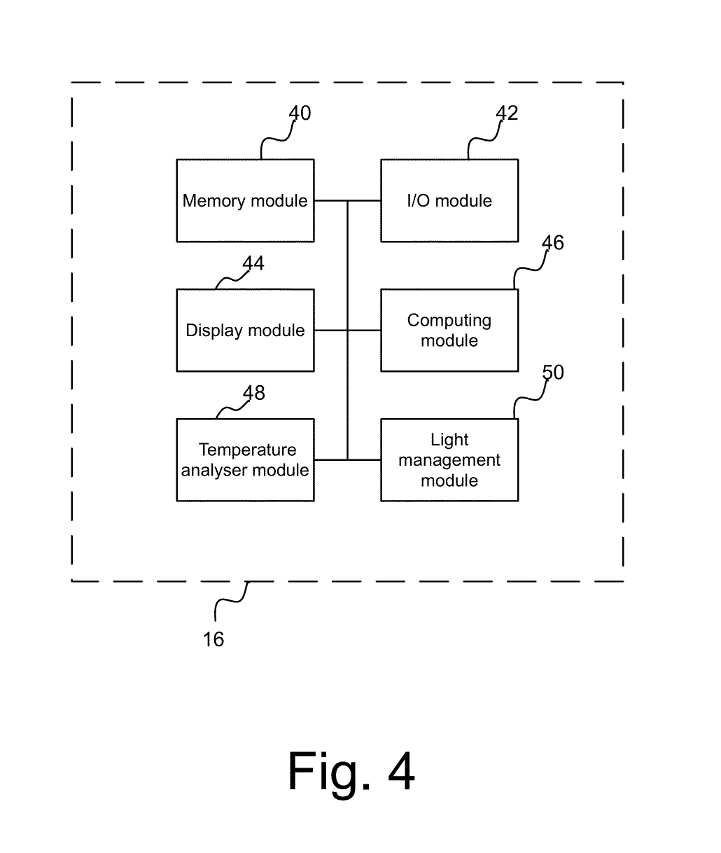

Turning now to FIG. 4 illustrating a typical management system 16 embedded in a cooling device 12 and better adapted to carry out embodiments of the present invention. The management system 16 comprises a memory module 40, adapted to store data and computer readable code therein, an input/output module 42 adapted to manage inputs and outputs such as user's provided inputs, network communications, temperature sensor signal and light intensity sensor signal. The management system 16 also includes a display module 44 adapted to visually interface with a user to provide dialogues therewith, a computing module 46 to establish proper outputs from the provided inputs calculated with computer readable instructions locally stored in the memory module 40 or/and remotely stored on the network, in addition to a temperature analyzer module 48 capable of determining when a temperature is not proper for efficient food conservation in the cooling device 12 and a light management module 50 capable or altering the internal light (or other lights) of the cooling device 12.

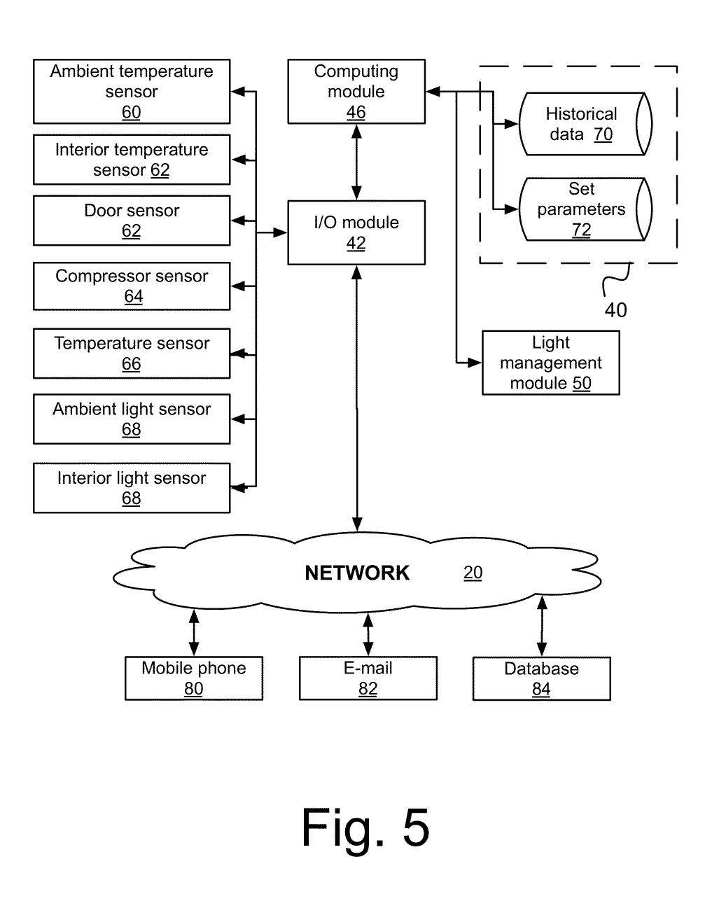

In FIG. 5 it can be appreciated the computing module 46 is connected to the I/O module 42 that itself is connected to an ambient temperature sensor 60 capable of sensing the temperature outside the cooling device 12, internal temperature sensing module 61 adapted to sense the temperature inside the cooling device 12, a door opening sensor 62 adapted to determine when the cooling device 12 door is open or closed (can use the close door sensor, the accelerometer and/or the door position sensor, a compressor sensor 64 capable of sensing when the compressor of the cooling device 12 is working properly or is not working properly, a internal temperature sensor 66 capable or sensing the internal temperature of the cooling device 12 and an ambient light sensor 68 adapted to sense the light intensity outside the cooling device 12. On the other side the memory module 40 comprises an historical database 70 storing historical data of the various data collected by each sensor over time. Another database records operating parameters set by a user of the cooling device 12, like, inter alia, limit temperatures acceptable in the cooling device 12 and communication data that will be discussed later in the description. Still referring to FIG. 5 the I/O module 42 is preferably (but not necessarily) connected to the network 20 with TCPIP to reach other communication devices like a mobile phone 80 to transmit a message to the cooling device 12 owner, send e-mails 82 to communicate to the owner via another channel or communicate to other databases 84 for global statistical analysis (for instance, that can be useful for cooling device manufactures in view of improving the quality of their products).

In a first illustrative embodiment, there is provided at least one ambient light intensity sensor 68 disposed outside the cooling device 12 that is sensing the ambient light intensity. Preferably, the external ambient light intensity sensor 68 can be disposed on the door of the cooling device 12 of on the frame of the cooling device 12 ideally in a place where the internal light of the cooling device will not be sensed by the external ambient light intensity sensor 68 to avoid altering the ambient quantity of light gathered by the external ambient light intensity sensor 68. An internal light intensity sensor 69 is also provided to appreciate the light strength inside the cooling device 12. The light intensity sensor 68 is connected to the I/O module 42 and its signal is received by the computing module 46 and the light management module 50 (not illustrated in FIG. 5) to determine what light intensity inside the cooling device 12 should be provided to prevent blinding the user when the door of the cooling device 12 is opened. If the ambient light is strong, the internal light of the cooling device 12 will be strong to provide sufficient light to appreciate goods stored inside the cooling device 12. In contrast, the internal light of the cooling device 12 will be low if the ambient light is low in order to prevent blinding of the person opening the cooling device 12 when the ambient light is low.

The intensity of the light inside the cooling device 12 can vary if the ambient light varies, or, the light inside the cooling device 12 can vary over time if the door remains open for a period of time and the user of the cooling device 12 has time to get used to stronger light inside the cooling device 12. The light inside the cooling device 12 can also be managed to anticipate the user's desire. For instance, the accelerometer and the door position sensor can be used to appreciate when the user closes the door of the cooling device 12 to begin progressively shutting down the light inside the cooling device 12. A rapid closing movement would be a good indication that the door is going to be closed soon and that no light inside the cooling device 12 is required anymore.

The ambient light sensor 68 could alternatively be disposed inside the cooling device 12 in a second embodiment and perform the same role. The ambient light sensor 68 should be located in a position allowing proper perception of the ambient light intensity as soon as the door of the cooling device 12 slightly opens to immediately reads input and send a signal to the computing module 46 for treatment and provide the appropriate internal light intensity. This way there is no ambient light sensor on the outside of the cooling device 12 and still provide similar results.

The first embodiment is preferable since the management system 16 can appreciate the ambient light intensity when the door of the cooling unit 12 remains closed. It is also possible to locate the ambient light intensity sensor in a place well adapted to receive a representative amount of ambient light in the surrounding of the cooling device 12.

A third embodiment provides a plurality of ambient light sensors 68 connected to the I/O module 42 providing signals to the computing module 46 that uses the light management module 50 to determine an average ambient light intensity used for the determination of the desirable internal light intensity in the cooling device 12.

The light management module 50 can also modify the type of lighting depending on other conditions like, for instance, the internal temperature of the cooling device 12. A fourth embodiment uses a temperature sensor 66 connected to the I/O module 42 that transfers the signal to the temperature analyzer module 48 to determine if the internal temperature of the cooling device 12 is correct or if it reaches outside predetermined temperature limits. The light management module 50 refers to conditions stored in the memory module 40 to determine if the internal light of the cooling device 12 should blink at a predetermined frequency, be constant or change color. An exemplary set of condition for a refrigerator could read as follows in Table 1:

TABLE 1

| Internal temperature of the | Interior light | Interior light | |
|---|---|---|---|
| cooling device | state | color | Sound |
| 1° C. < T° < 4° C. | Constant | White | None |
| 0° C. < T° < 1° C. | Constant | Blue | None |
| 4° C. < T° < 5° C. | Constant | Red | None |
| T° > 0° C. | Blinking | Blue | None |
| T° < 5° C. | Blinking | Red | None |
| T° < 6° C. | Blinking | Red | Beeping |

Multiple colors LED lights can be managed to change color easily and provide a variety of light colors when desired. In the present example the blue color is associated with a temperature that is too cold, the red color for too warm. White balance can also be adjusted to provide a better vision of the food in the cooling device 12.

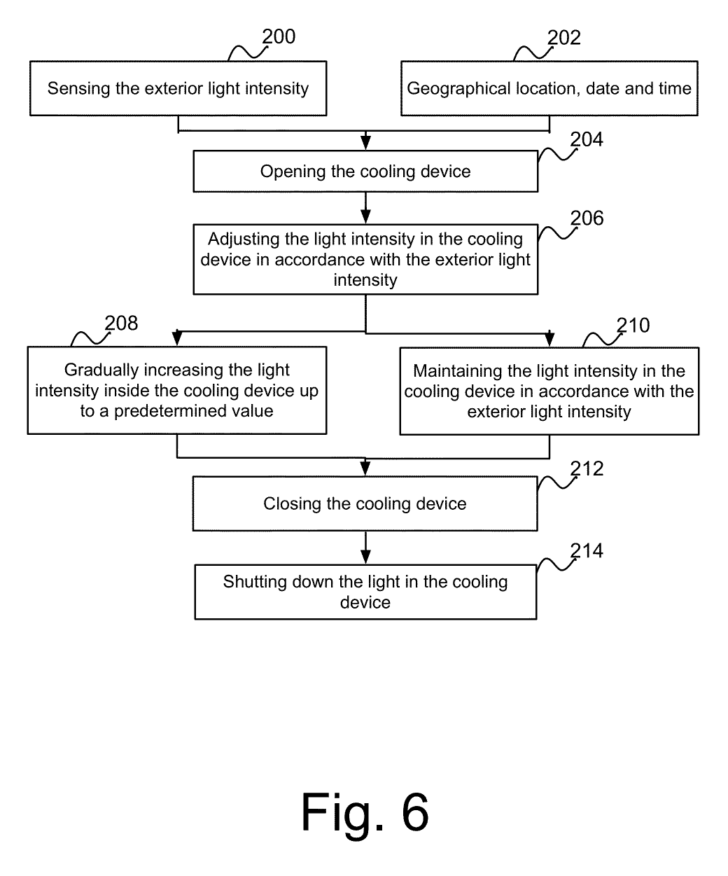

FIG. 6 illustrates an exemplary flow chart of an embodiment using either, or in combination, a signal from the exterior light intensity 200 and/or the geographical location, date and time to determine the exterior light intensity. The knowledge of the specific region on the planet where a cooling device 12 is installed, the time of the year and the day could alternatively be used to adjust the interior light intensity 206 when the refrigerator door is open 204. Of course this embodiment is more complicated than the use of the signal of a light sensor but it can provide indications of the general state of natural light to manage the interior light intensity. The interior light intensity can increase over time 208 or be maintained at a constant intensity proportional to the ambient light intensity 210. If the door is closed 212 the interior light is normally shut down 214 although it could remain opened for other reasons like food conservation that are not detailed therein.

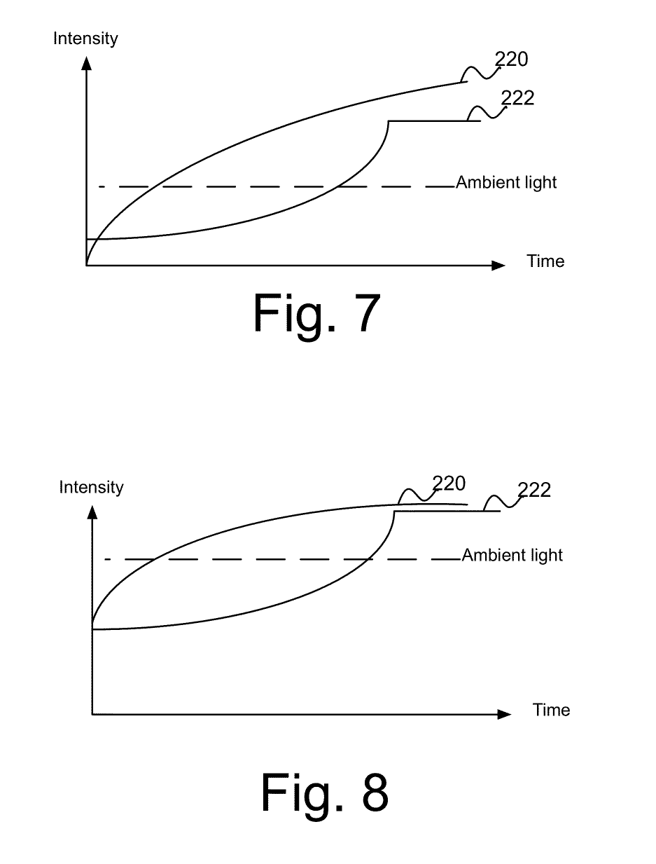

Referring now to FIG. 7 one can appreciate two distinct curves 220, 222 located on the graph representing the ambient light intensity. Assuming the point 0,0 on the graph is the moment in time when the door is opening, the first curve 220 represents the interior light intensity of a cooling device 12 that begins at a zero value and logarithmically increases over time to a maximum intensity. The second curve 222 begins at a non-zero value and exponentially grows until it reaches a plateau.

In contrast, FIG. 8 offers a different layout in function of a brighter ambient light intensity. In the latter case the two curves 220, 220 illustrates two scenarios where the interior light goes off with a non-zero intensity (that could be analogous to daylight condition of use while the graph illustrated in FIG. 7 relates to a night time lighting condition of use).

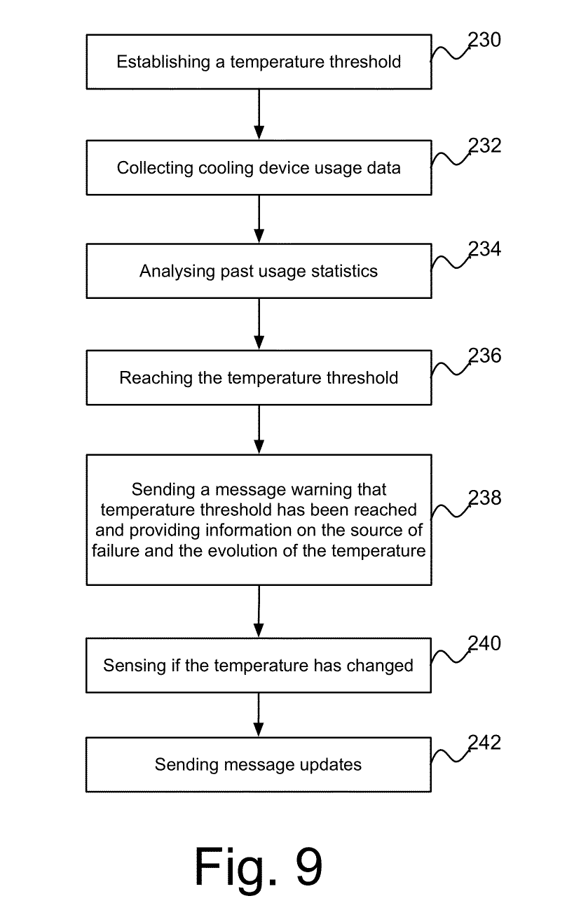

The network 20 connected management system 16 of the present invention provides additional functions. One of them is illustrated with the exemplary flowchart of FIG. 9. A user or a signal from the network 20 set a temperature threshold 230 for the cooling device 12 internal temperature. Data of use of the cooling device 12 is collected over time 232 to infer and store statistics of use 234. When a temperature threshold is reached a message is sent to a predetermined SMS address, email address or telephone number (or all of them at the same time) to warn the owner or the person responsible of the cooling device 12 that the cooling device 12 is likely not properly functioning and that the temperature threshold has been reached.

Other additional information on the temperature evolution is provided in the same message and is based on the statistical analysis of the data of use. For instance, the message could tell that the refrigerator interior temperature is now at 4° C. and that this is the upper preset threshold. This temperature has never been reached before. The door is closed but the compressor sensor 64 indicates that the compressor has stopped working 43 minutes ago and there is still grid electricity detected. The temperature variation estimate assumes that it will take 15 more minutes to reach the critical temperature of 5.5° C. and the food contained in the refrigerator can presumably be saved if an action is taken within the next 15 minutes. As for the freezer, it is estimated it will take 7.3 hours before it begin to thaw. Updates are provided 240, 242 when required. One can understand the underneath principle and see other types of messages to send when there is an issue with the cooling device 12.

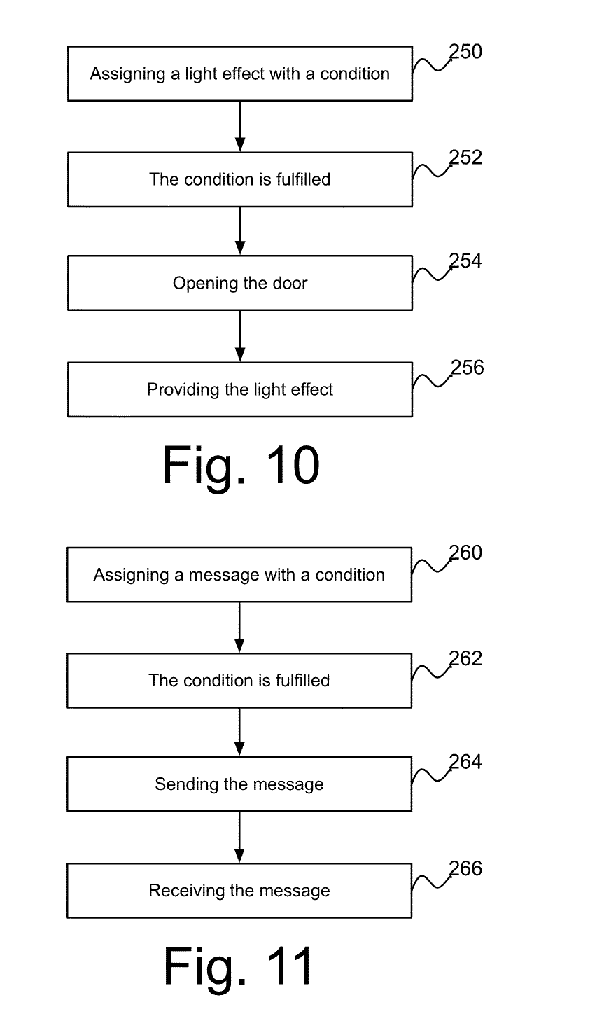

FIG. 10 illustrates a few exemplary steps where fulfilled conditions are associated with an interior light effect 250 (as indicated in Table 1). If the condition is fulfilled 252 the interior light will use the effect associated with the fulfilled condition 256 when the door is opened 254. The effect can also be a noise emitted alone of in conjunction with a light effect without departing from the scope of the present disclosure.

FIG. 11 depicts a few steps analogous to the steps of FIG. 10 but rather associated with a message sent to the user or a person responsible of the cooling devices 12. Messages are assigned to conditions 260 (the conditions could be related to the temperature in the cooling device 12 as indicated in Table 1 above). A specific message is sent 264 (SMS, Email, phone or other) through the network 20 when a predetermined condition is fulfilled 262. The recipient receives the message 266 and can take appropriate actions to fix the issue in cause.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A non-transitory computer-readable medium adapted to store thereon computer-readable instructions that, when executed with a computer, provide a method of informing of an appliance malfunction, the method comprising:
detecting a door of an appliance is open; and
transmitting a message through a network when a predetermined threshold is exceeded to warn the door of the appliance is open.

2. The non-transitory computer-readable medium of claim 1, wherein the threshold is a duration.

3. The non-transitory computer-readable medium of claim 1, wherein the threshold is a temperature inside the appliance.

4. The non-transitory computer-readable medium of claim 1, wherein the message is electronically transmitted through a wireless communication network.

5. The non-transitory computer-readable medium of claim 1, wherein the message is one of a text message and an email.

6. The non-transitory computer-readable medium of claim 1, wherein the message is adapted to include appliance use data.

7. The non-transitory computer-readable medium of claim 1, wherein the appliance is an apparatus for reducing temperature to extend food conservation.

8. The non-transitory computer-readable medium of claim 1, wherein the message provides a time estimation for closing the door before food is lost.

9. The non-transitory computer-readable medium of claim 1, wherein the appliance includes a light including a first state representative of a normal state and a second state representative of a non-normal state, the method further comprising applying the second state to the light when the predetermined threshold is exceeded.

10. The non-transitory computer-readable medium of claim 1, wherein the message provides information about a compressor operatively connected to the appliance.

11. The non-transitory computer-readable medium of claim 1, further comprising, when the door of the appliance is closed, sending another message indicating the appliance operates normally.

12. A non-transitory computer-readable medium adapted to store thereon computer-readable instructions that, when executed with a computer, provide a method of warning of an appliance malfunction, the method comprising:
detecting an appliance malfunction; and
transmitting message through a network to warn the appliance has a malfunction.

13. The non-transitory computer-readable medium of claim 12, wherein the message is a wireless electronic communication.

14. The non-transitory computer-readable medium of claim 12, wherein the message is one of a text message and an email.

15. The non-transitory computer-readable medium of claim 12, wherein the message is adapted to include appliance use data.

16. The non-transitory computer-readable medium of claim 12, wherein the appliance is an apparatus for reducing temperature to lengthen conservation of food.

17. The non-transitory computer-readable medium of claim 12, wherein the appliance includes a light including a first state of operation, representative of a normal state, and a second state of operation, representative of a malfunction state, the method further comprising applying the second state to the light when the appliance is in the malfunction state.

18. The non-transitory computer-readable medium of claim 12, wherein the message provides information about a compressor operatively connected to the appliance.

19. The non-transitory computer-readable medium of claim 12, further comprising, when the appliance is in a normal state of operation, sending another message indicating the apparatus operates normally.

20. An appliance for storing food therein, the appliance comprising:
a body defining a cavity including a light therein and adapted to maintain a substantially stable temperature;
a door adapted to close the cavity to prevent temperature exchange with the environment of the body;
a display operatively connected to the apparatus for interfacing with a user;
an internal sensing module adapted to sense a physical state of the appliance; and
an I/O module adapted to send a signal indicative of an apparatus malfunction, the I/O module being adapted to send the signal through a network to reach a mobile device.
